(19) United States
(12) Patent Application Publication
(10) Pub. No.: US 2006/0271321 A1
(43) Pub. Date: Nov. 30, 2006

(54) Initiating calibration mode of electronic control module

(75) Inventors: David J. Rutkowski, Grosse Isle, MI (US); John H. Floros, Novi, MI (US); Imad Sharaa, Farmington, MI (US)

Correspondence Address: VISTEON, C/O BRINKS HOFER GILSON & LIONE, PO BOX 10395, CHICAGO, IL, 60610, US

(73) Assignee: Visteon Global Technologies, Inc.

(21) Appl. No.: 11/135,773

(22) Filed: May 24, 2005

(51) Int. Cl. G06F 19/00

(52) U.S. Cl. 702/105

(57) ABSTRACT

Disclosed is an actuator having an electronic control module having a port and a controller in communication with the port, as well as software for instructing the controller to detect a calibration signal from the port and transmit an acknowledgment signal to the port. The actuator is placed in a calibration mode by monitoring the port be monitored for the calibration signal. Once it has been determined that the port has received the calibration signal, the actuator will be placed in the calibration mode and an acknowledgment signal will be transmitted to the port.

### BACKGROUND

1. Field of the Invention

The present invention generally relates to a method of placing an electronic control module (ECM) of an actuator in a calibration mode and, more particularly, to a system and method of placing an ECM in a calibration mode with the ECM having only one input/output command line.

2. Description of the Known Technology

Automobiles are equipped with actuators to perform tasks, such as opening and closing the ventilation passageways of a heating, ventilation and air conditioning (HVAC) unit and the opening and closing of the intake manifold passageway of an internal combustion engine. The actuator itself is controlled by an ECM that includes a control input for receiving a control command, which will be interpreted by the ECM to command the actuator to either open or close the passageways. Many applications require that the passageways be opened and/or closed by a specific and predetermined amount. Therefore, the ECM must be calibrated so that the passageways are opened and/or closed by the actuator at the precise and predetermined amount.

One such way of placing the ECM in a calibration mode requires that the ECM have a calibration input separate from the command input. With is system, a calibration signal is placed on the calibration input and the ECM will place itself in the calibration mode. Other solutions require that the ECM be connected to the Controller Area Network (CAN) in addition to having the separate command input. These solutions have the drawback of requiring that the ECM have multiple inputs.

Therefore, it is desirable to provide a system and method for calibrating an ECM that requires only one input for placing the ECM in the calibration, as well as controlling the ECM.

### BRIEF SUMMARY

In overcoming the drawbacks and limitations of the known technology, a system and method for placing an actuator in a calibration mode is disclosed. As defined herein, the actuator includes an electronic control module having a port and a controller in communication with the port, as well as software for instructing the controller to detect a calibration signal from the port and transmit an acknowledgment signal to the port. The actuator may further include a motor in communication with the controller. The motor will turn a shaft, either directly or via a gear train. The method for placing an actuator in the calibration mode requires that the port be monitored for the calibration signal. Once it has been determined that the port has received the calibration signal, the actuator will be placed in the calibration mode. Thereafter, an acknowledgment signal will be transmitted to the port.

By way of example, the calibration signal may be a 1 kHz signal for 250 ms followed by a 2 kHz signal for 250 ms. Alternatively, the calibration signal may vary and differ from that described above. The acknowledgment signal, as by way of example only, may be a 10% duty cycle signal. Obviously, the duty cycle may vary and differ from that described above.

These and other advantages, features, and embodiments of the invention will become apparent from the drawings, detailed description, and claims, which follow.

### BRIEF DESCRIPTION OF THE DRAWINGS

FIG. 1 is a side view of an actuator embodying the principles of the present invention; and

FIG. 2 is a cross-sectional view, generally taken along line 2-2, of the actuator seen in FIG. 1.

### DETAILED DESCRIPTION

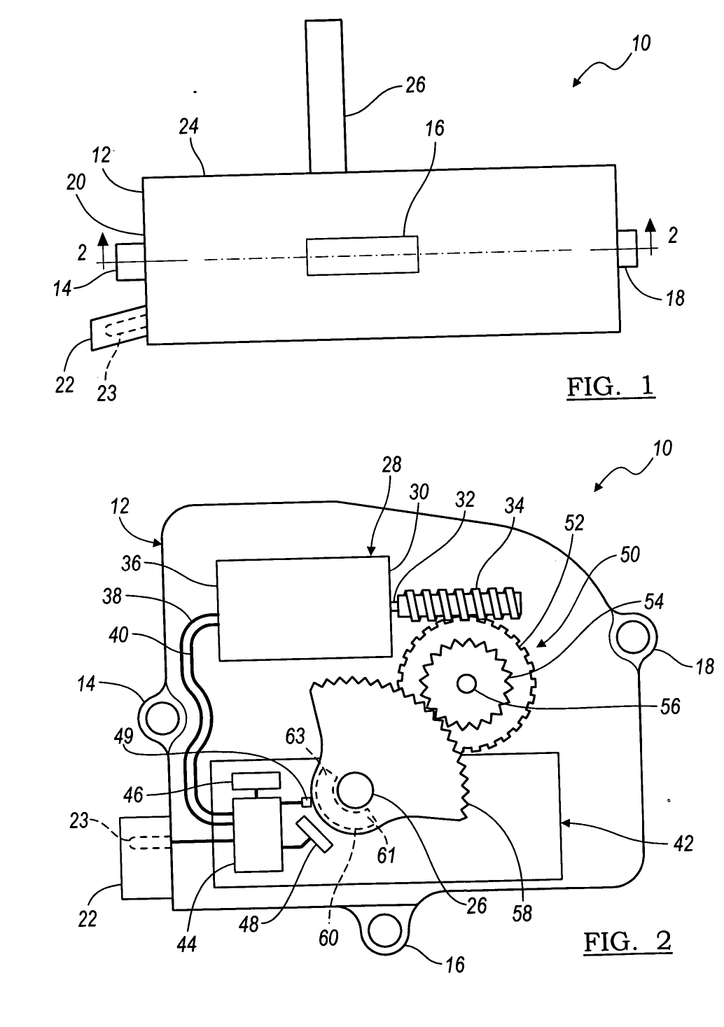

Referring to FIG. 1, an actuator 10 is illustrated therein and includes a housing 12 having mounting points 14, 16, 18. The housing is typically made of plastic but may be made of metal. Extending from a side 20 of the housing 12 is an electrical connector 22 that allows for outside communication with the actuator 10 via a pin 23. Extending from a one side 24 of the housing 12 is an output shaft 26. Generally, the shaft 26 is made of a metal, such as steel, but may alternatively be made of plastic.

Referring now to FIG. 2, inside the housing 12 is located a motor 28, preferably an electrical motor of conventional construction. At a first end 30 of the motor 28 is an output 32 extends from one end 30 of the motor 28. Also extending from the motor 28 are motor control lines 38, 40.

In addition to the motor 28, disposed within the housing 12, is an electronic control module (ECM) 42 that is connected to the motor 28 via the control lines 38, 40. The ECM 42 includes a controller 44, a memory unit 46, and a Hall Effect sensor 48 and a diode 49. Generally, the memory unit is a non-volatile memory unit in electrical communication with the controller 44. Alternatively, the controller 44 may contain an integrated memory unit, thus relinquishing the need of the memory unit 46.

The output 32 of the motor 28 is coupled to the output shaft 26 of the actuator 10 by way of a gear train 50 the gear train 50 includes a worm gear 34, a first sprocket 52, and a second sprocket 54. Generally, the first and second sprockets 52, 54 are made of plastic, but may be made of an alternative material, such as steel.

The worm gear 34 is mounted on, and rotates with, the output 32 of the motor 28. The worm gear 34 mechanically engages a first sprocket 52 and will rotate the sprocket 52 around the axis 56. The first sprocket 52, first is coupled to a second sprocket 54, which is concentric therewith and will also rotate around the axis 56.

The teeth on the second sprocket 54 engage corresponding teeth on a shaft sprocket or bell gear 58, which is in turn connected to the output shaft 26 of the actuator 10 so as to rotate therewith. Thus, when the second sprocket 54 is caused to rotate, the shaft sprocket 58 will rotate causing the output shaft 26 to correspondingly rotate.

Also coupled to the shaft sprocket 58 is a magnet 60. The Hall Effect sensor 48 is located proximate to the magnet 60 so that the magnetic field created by the magnet 60 can be detected by the Hall Effect sensor 48. With regard to the magnet 60, the magnet 60 is oriented such that during rotation of the shaft sprocket 58 the magnet's poles 61, 63 are caused to move relative to the Hall Effect sensor 48. The diode 49 is also placed proximate to both the magnet 60 and the Hall Effect sensor 48. The diode 49 is sensitive to temperature and will produce a voltage signal indicative of the temperature in the surrounding area, including the area near the Hall Effect sensor 48 and the magnet 60. The magnet 60 may be a neodymium iron boron (NeFeB) magnet but may be a Samarian cobalt (SmCo) magnet.

During operation of the actuator 10, the controller 44 continuously monitors the pin 23 of the electrical connector 22 for a calibration signal. Since the pin 23 of the electrical connector 22 may be used for other purposes, such as for receiving a signal for instructing the actuator 10 to rotate the shaft 26, the calibration signal must be unique enough for the controller 44 to differentiate it from other signals.

One of many possible constructs for the calibration signal is a 1 kHz signal for 250 ms followed by a 2 kHz for 250 ms. The only requirement for this signal is that the calibration signal be unique enough for the controller 44 to differentiate it from other signals.

Once the controller 44 has determined that the pin 23 of the electrical connector 22 has received the calibration signal, the controller 44 will place the actuator 10 in a calibration mode and output an acknowledgment signal, such as a 10% duty cycle signal, through the pin 23 of the electrical connector 22. Alternatively, the acknowledgment signal, may vary from the example. The only requirement for the acknowledgment signal being that acknowledgment signal is unique enough for an outside device (connected to the pin 23 of the electrical connector 22) to be able to differentiate the acknowledgment signal from other signals.

After the actuator 10 has been placed into the calibration mode, the actuator 10 may follow any number of calibration methods. One such method utilized relates to calibrating the output of the Hall Effect sensor 48 after final assembly of the actuator 10.

This method first requires that the shaft 26 is moved to a first position. This may be accomplished by an external force or by the motor 28. If the motor 28 is used to rotate the shaft 26 to the first position, the controller 44 instructs the motor 28 to rotate the shaft 26 in a first direction while the controller 44 monitors the output of the Hall Effect sensor 48. When the output of the Hall Effect sensor 48 is no longer changing over a period of time, the controller 44 determines that the shaft 26 has reached the first position and the controller 44 instructs the motor 28 to stop rotating the shaft 26 in the first direction. Afterward, the controller 44 takes a reading from the Hall Effect sensor 38 and stores the reading in the memory unit 46 as a first stop value.

Next, the shaft 26 is moved to a second position. Similarly, this may be accomplished by an external force or by the motor 28. If the motor 28 is used to rotate the shaft 26 to the second position, the controller 44 instructs the motor 28 to rotate the shaft in a second direction and the controller 44 monitors the output of the Hall Effect sensor 48. When the output of the Hall Effect sensor 48 is no longer changing, the shaft 26 has reached the second position and the controller 44 instructs the motor 28 to stop rotating the shaft 26 in the second direction. Afterward, the controller 44 takes a reading from the Hall Effect sensor 48 and stores the reading in the memory unit 46 as a second stop value.

When operation, the shaft 26 will be required to rotate to either the first position or the second position. Using the previously stored first and second stop values, the controller 44 is be able to determine when the shaft 26 has reached either the first position or the second position. This is done by having the controller 44 monitor the output of the Hall Effect sensor 48 and compare the output of the Hall Effect sensor 48 to the first and second stop values. When the output of the Hall Effect sensor 48 approximately matches the first or second stop value, the controller determines that the shaft 26 has reached either the first position or the second position and instructs the motor 28 to stop rotating the shaft 26.

Another method that may be used in calibrating the actuator 10 is adjusting the output of the Hall Effect sensor 48 for changes in the temperature in the magnet 60 and the Hall Effect sensor 48. Similar to the previously described method, the shaft 26 is moved to the first position and the second position by either and external force or the motor 28. Likewise, the first stop value and second stop value are stored in the memory unit 46.

Additionally, a reading from a diode 49 is stored in the memory unit 46 as a calibration temperature value. The calibration temperature value is representative of the temperature near the magnet 60 and the Hall Effect sensor 48. Preferably the first stop value, the second stop value and the calibration temperature value is measured and stored in the memory unit 46 when the temperature of the magnet 60 and the Hall Effect sensor 48 is 25 degrees C.

When in operation, the output of the Hall Effect sensor 48 will vary as the temperature of the Hall Effect sensor 48 and the magnet change. The output of the diode 48, being near the Hall Effect sensor 48 and the magnet 60, will change in accordance to the change in temperature to the Hall Effect sensor 48 and the magnet 60.

During operation, the output of the diode 49 is monitored and converted to a current temperature value. The current temperature value is then subtracted from the calibration temperature value to obtain a temperature difference value. Using the temperature difference value, the controller calculates a correction factor. The correction factor may be calculated by using empirical data stored in the memory unit 46. The correction factor is then added to the first stop value and subtracted from the second stop value to obtain a compensated first stop value and a compensated second stop value.

In operation, the shaft 26 will be required to rotate to either the first position or the second position. Using the previously calculated compensated first and second stop values, the controller 44 will be able to determine when the shaft 26 has reached either the first position or the second position. These is done by having the controller 44 monitor the output of the Hall Effect sensor 48 and compare the output of the Hall Effect sensor 48 to the compensated first and second stop values. When the output of the Hall Effect sensor 48 approximately matches the compensated first or second stop value, the controller will determine that the shaft 26 has reached either the first position or the second position and instruct the motor 28 to stop rotating the shaft 26.

The foregoing description of the embodiment of the invention has been presented for purposes of illustration and description. It is not intended to be exhaustive or to limit the invention to the precise embodiment disclosed. Numerous modifications or variations are possible in light of the above teaching. The embodiment discussed was chosen and described to provide the best illustration of the principles of the invention in its practical application to thereby enable one of ordinary skill in the art to utilize the invention in various embodiments and with various modifications as are suited to the particulate use contemplated. All such modifications and variations are within the scope of the invention as determined by the appended claims when interpreted in accordance with the breadth to which they are fairly, legally, and equitably entitled.

1. An actuator comprising:
an electronic control module having a single port and a controller in communication with the port;
the controller being configured to detect a calibration signal from the single port and transmit an acknowledgement signal to the single port;
a motor coupled to the ECM; and
an output shaft coupled to the motor so as to be rotated thereby.

2. The actuator of claim 1, further comprising a gear train in mechanical communication between the motor and the output shaft.

3. The actuator of claim 1, wherein the electronic control module includes a memory unit in communication with the controller.

4. The actuator of claim 3, wherein the memory unit is a non-volatile memory unit.

5. The actuator of claim 1, wherein the single port is a pin.

6. The actuator of claim 1, wherein the electronic control module further comprises a sensor in communication with the controller.

7. The actuator of claim 6, wherein the sensor is Hall Effect sensor and further comprising a magnet configured to output a magnetic field, the magnetic field indicative of the position of the shaft.

8. The actuator of claim 7, further comprising a diode in communication with the controller and configured to output a voltage indicative of the temperature of the magnet and the Hall Effect sensor.

9. A method for placing an actuator in a calibration mode, the method comprising:
monitoring a port for a calibration signal;
placing the actuator in the calibration mode; and
transmitting and acknowledgement signal to the port.

10. The method of claim 11, wherein the calibration signal is a 1 kHz signal for 250 ms followed by a 2 kHz signal for 250 ms.

11. The method of claim 11 wherein the acknowledgement signal is a 10% duty cycle signal.
